(19) United States
(12) Patent Application Publication
(10) Pub. No.: US 2007/0008248 A1
(43) Pub. Date: Jan. 11, 2007

(54) Plasma display apparatus and driving method thereof

(75) Inventors: Yunkwon Jung, Gumi-si (KR); Gun Su Kim, Seongnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/476,117

(22) Filed: Jun. 28, 2006

Related U.S. Application Data
(63) Continuation-in-part of application No. 11/328,100, filed on Jan. 10, 2006.

(30) Foreign Application Priority Data
Jul. 15, 2005 (KR) 10-2005-064045
Jul. 5, 2005 (KR) 10-2005-060487

(51) Int. Cl. G09G 3/28

(52) U.S. Cl. 345/67

(57) ABSTRACT

Embodiments of the present invention may prevent an afterimage-generating wrong discharge when a plasma display panel is driven. A driving pulse controller may control a driver to sequentially apply a first falling waveform and a second falling waveform to the scan electrode and to apply a positive waveform to the sustain electrode while applying the first falling waveform in a reset period.

This application is a Continuation-In-Part application of U.S. patent application Ser. No. 11/328,100, filed Jan. 10, 2006, the subject matter of which is incorporated herein by reference.

This nonprovisional application also claims priority under 35 U.S.C. §119 from Korean Patent Application No. 10-2005-064045 filed on Jul. 15, 2005 and Korean Patent Application No. 10-2005-060487 filed on Jul. 5, 2005, the entire contents of which are hereby incorporated by reference.

### BACKGROUND OF THE INVENTION

1. Field of the Invention

Embodiments of the present invention may relate to a plasma display apparatus. More particularly, embodiments of the present invention may relate to a plasma display apparatus that is capable of preventing an afterimage-generating wrong discharge from occurring when a plasma display panel is driven.

2. Description of Background Art

A plasma display apparatus may include a plasma display panel in which barrier ribs are formed between a front substrate and a rear substrate to partition unit cells. Main discharge gas, such as Ne, He, or He−Xe mixture (He+Xe), and inert gas containing a small amount of Xe may be filled in each cell. When a discharge is performed by a high-frequency voltage, the inert gas may generate vacuum ultraviolet rays and excite phosphors formed between the barrier ribs, thereby forming an image. Such a plasma display apparatus may be considered a next-generation display apparatus since it may be manufactured to be thin in thickness and light in weight.

### SUMMARY OF THE INVENTION

An object of the present invention is to solve at least problems and disadvantages of background art.

Embodiments of the present invention may provide a plasma display apparatus that is capable of preventing an afterimage-generating wrong discharge.

Embodiments of the present invention may also provide a plasma display apparatus that is capable of preventing spots from being created on a displayed single color pattern.

Embodiments of the present invention may also provide a plasma display apparatus that is capable of preventing screen distortion from occurring due to applied pulses (or signals or waveforms).

In at least one embodiment, a plasma display apparatus may be provided that includes a plasma display panel on which a plurality of sustain electrode pairs are formed, each including a scan electrode and a sustain electrode. A driver may also be provided to drive each sustain electrode pair. A driving pulse controller may control the driver to sequentially apply a first falling waveform (or first decreasing waveform) in the reset period and a second falling waveform in the reset period to the scan electrode and to apply a positive waveform to the sustain electrode while applying the first falling waveform in the reset period.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to sequentially apply a first falling waveform in the reset period and a second falling waveform in the reset period decreasing from the same voltage level as the first falling waveform to the scan electrode and to apply a positive waveform to the sustain electrode while applying the first falling waveform in the reset period.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to apply a first falling waveform decreasing from a first voltage level lower than the maximum voltage level of a set-up waveform and then to apply a second falling waveform decreasing from a second voltage level lower than the first voltage level to the scan electrode, and to apply a positive waveform to the sustain electrode while applying the first falling waveform in the reset period.

In at least one embodiment, a plasma display apparatus may include a plasma display panel having a plurality of sustain electrode pairs, each including a scan electrode and a sustain electrode. A driver may drive each sustain electrode pair. A driving pulse controller may control the driver to apply a first falling waveform and a second falling waveform whose minimum voltage levels are negative to the scan electrode, to apply a positive waveform to the sustain electrode while applying the first falling waveform and to apply a ground voltage (GND) to the sustain electrode while applying the second falling waveform in the reset period.

In at least one embodiment, a driving method of a plasma display apparatus may be provided. The plasma display apparatus may include discharge cells formed by a plurality of sustain electrode pairs, each including a scan electrode and a sustain electrode, and a plurality of address electrodes intersecting the plurality of sustain electrode pairs. The driving method may include: (a) applying a set-up waveform to the scan electrode; (b) applying a first falling waveform whose minimum voltage level is negative to the scan electrode and applying a positive waveform to the sustain electrode while the first falling waveform is applied; and (c) applying a second falling waveform whose minimum voltage level is negative to the scan electrode.

Embodiments of the present invention may suppress the occurrence of an afterimage-generating wrong discharge. Also, embodiments of the present invention may prevent spots from appearing in a displayed single color pattern. Further, embodiments of the present invention may prevent screen distortion from being generated. Furthermore, embodiments of the present invention may prevent a complementary color afterimage from appearing on a displayed image.

Other objects, advantages and salient features of the invention will become apparent from the following detailed description taken in conjunction with the annexed drawings, which disclose preferred embodiments of the invention.

### BRIEF DESCRIPTION OF THE DRAWINGS

Embodiments of the present invention may be described in detail with reference to the following drawings in which like numerals refer to like elements and wherein:

FIG. 1 is a perspective view of a plasma display panel according to an example arrangement;

FIG. 2 is a view for explaining an image forming method used in a plasma display apparatus according to an example arrangement;

FIG. 3A shows timing diagrams illustrating driving waveforms that are used in the plasma display apparatus according to an example arrangement;

FIG. 3B shows a view for explaining wall charge distributions of discharge cells by the driving waveforms illustrated in FIG. 3A according to an example arrangement;

FIG. 4 is a view for explaining structure of a plasma display apparatus according to a first embodiment of the present invention;

FIG. 5A shows timing diagrams of driving waveforms that are used in the plasma display apparatus according to the first embodiment of the present invention;

FIG. 5B is a view for explaining wall charge distributions of discharge cells by the driving waveforms illustrated in FIG. 5A according to the first embodiment of the present invention;

FIG. 6 shows waveforms for explaining a relationship between a set-up waveform and a first failing waveform used in the plasma display apparatus according to the first embodiment of the present invention;

FIG. 7 shows modified waveforms that are used in the plasma display apparatus according to the first embodiment of the present invention;

FIG. 8 shows timing diagrams for explaining a waveform including a pre-reset waveform that is used in the plasma display apparatus according to the first embodiment of the present invention;

FIG. 9 is a view for explaining structure of a plasma display apparatus according to a second embodiment of the present invention; and

FIG. 10 shows timing diagrams of driving waveforms that are used in the plasma display apparatus according to the second embodiment of the present invention.

### DETAILED DESCRIPTION

Arrangements and embodiments of the present invention will be described in a more detailed manner with reference to the drawings.

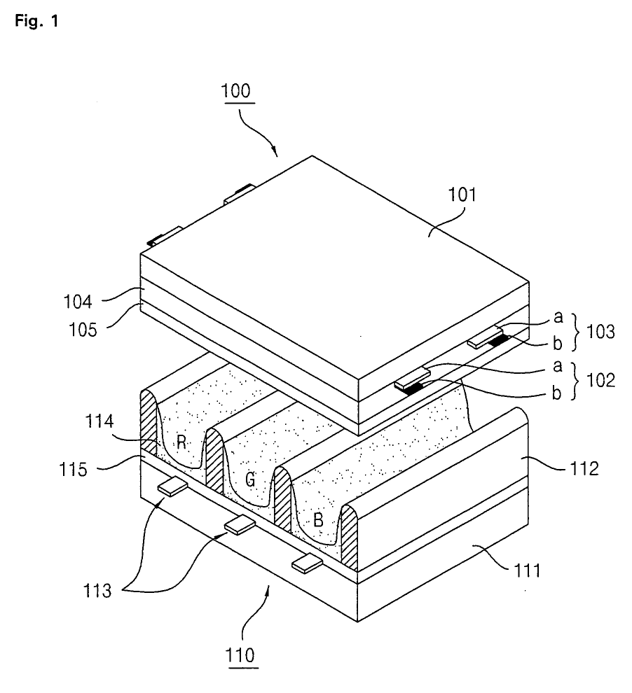

FIG. 1 is a perspective view of a plasma display panel according to an example arrangement. Other arrangements are also possible. More specifically, FIG. 1 shows the plasma display panel includes a front panel 100 including a front substrate 101 on which images are displayed and a plurality of sustain electrode pairs, each including a scan electrode 102 and sustain electrode 103. The front panel 100 may be coupled a predetermined distance in parallel with a rear panel 110 including a rear substrate 111 on which a plurality of address electrodes 113 are arranged in a manner to intersect the plurality of sustain electrode pairs.

In the front panel 100, the scan electrode 102 and the sustain electrode 103 are arranged in pairs, which are respectively used for discharging each discharge cell and for maintaining the luminescence of the discharge cell. Each of the scan electrode 102 and the sustain electrode 103 may be composed of a transparent electrode “a” made of a transparent material, such as Indium-Tin-Oxide (ITO), and a bus electrode “b” made of a metal material. At least one dielectric layer 104 for limiting a discharge current and isolating the electrode pairs may be formed to cover the scan electrode 102 and the sustain electrode 103. A protection layer 105 (e.g. a MgO layer) for facilitating a discharge may be formed on the dielectric layer 104.

In the rear panel 110, barrier ribs may be arranged in a stripe type (or in a well type) to form a plurality of discharge spaces, (i.e., a plurality of discharge cells). At least one address electrode 113 for performing an address discharge is formed parallel to the barrier ribs to enable inert gas in each discharge cell to generate vacuum ultraviolet rays. Phosphors 114 of Red (R), Green (G), and Blue (B) for emitting visible rays and displaying an image when a sustain discharge is performed are formed on the upper surface of the rear panel 110. A dielectric layer 115 for protecting the address electrode 113 is inserted between the address electrode 113 and the phosphors 114.

The plasma display panel with the above structure may be driven by a driving apparatus (not shown) including driving circuits for supplying predetermined pulses (or signals or waveforms) to a plurality of discharge cells that are formed in a matrix structure.

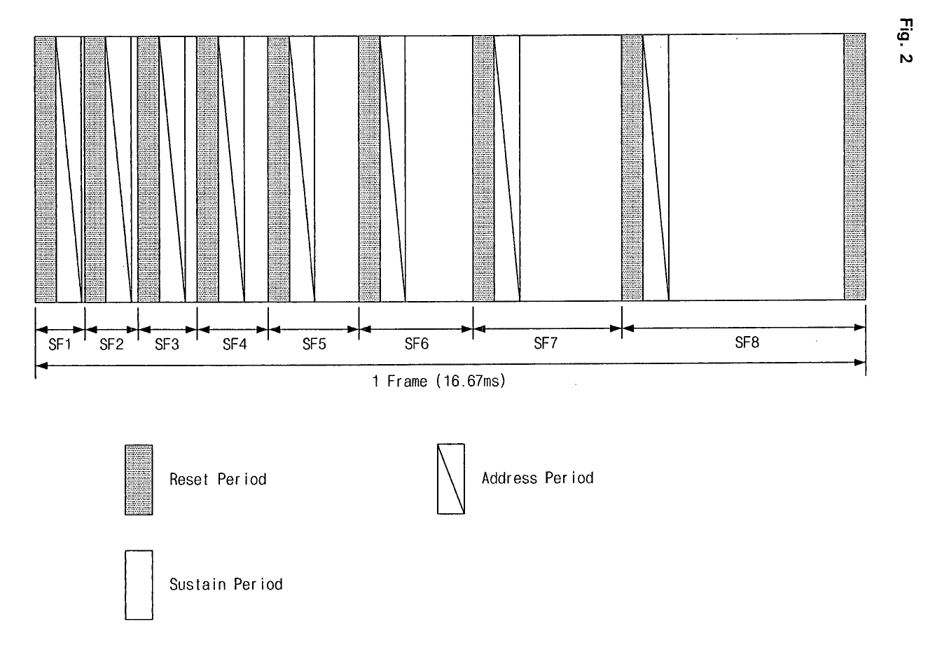

FIG. 2 is a view for explaining an image forming method used in a plasma display apparatus according to an example arrangement. Other arrangements are also possible. More specifically, FIG. 2 shows that the plasma display apparatus divides a frame period into a plurality of subfields with different numbers of discharges and emits light on a plasma display panel during a subfield period corresponding to a gray-level of an input image signal, thereby forming an image.

Each subfield may be divided into a reset period for performing a uniform discharge, an address period for selecting discharge cells, and a sustain period for representing a gray-level according to the number of discharges. For example, in order to display an image in 256 gray-levels, a frame period (16.67 ms) corresponding to 1/60 of a second is divided into 8 subfields.

Each of the 8 subfields may be divided into a reset period, an address period, and a sustain period. The durations of the sustain periods of the 8 subfields may sequentially increase at a rate of 2ⁿ (n=0, 1, 2, 3, 4, 5, 6, 7). As such, since the sustain periods of the respective subfields are different from each other, a gray-level of an image may be represented.

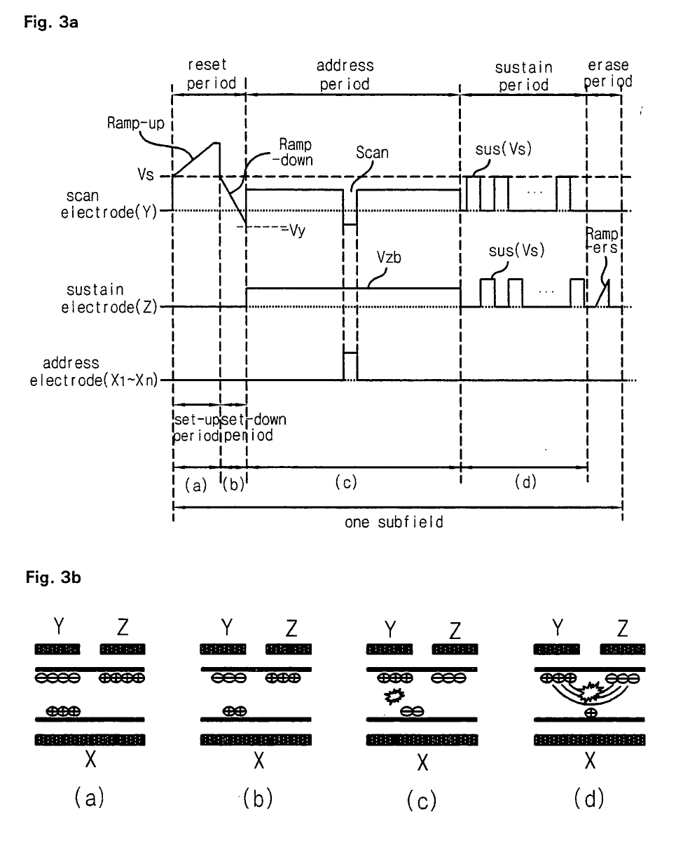

A driving method of the plasma display apparatus will now be described with reference to FIGS. 3A and 3B. More specifically FIG. 3A shows timing diagrams illustrating driving waveforms that are used in the plasma display apparatus according to an example arrangement. Other arrangements are also possible.

As shown in FIG. 3A, the plasma display apparatus is driven to include a reset period for initializing all cells, an address period for selecting cells to be discharged, a sustain period for sustain-discharging the selected cells, and an erase period for erasing wall charges in the discharged cells. The reset period may include a set-up period and a set-down period.

In the set-up period of the reset period, a set-up waveform Ramp-up of a rising ramp pulse (or signal or waveform) may be applied simultaneously to all scan electrodes. Thus, a weak dark discharge (set-up discharge) may occur in all discharge cells on the entire screen based on the set-up waveform. Due to the set-up discharge, positive wall charges are accumulated on address electrodes and sustain electrodes and negative wall charges are accumulated on the scan electrodes.

After the set-up waveform is applied, during the set-down period, a set-down waveform Ramp-down of a decreasing ramp pulse (or signal or waveform) is applied. The set-down waveform may decrease from a voltage level lower than a maximum voltage level of the set-up discharge to a predetermined negative voltage level. The set-down waveform may generate a weak erase discharge (set-down discharge) in the cells to thus sufficiently erase wall charges excessively formed on the scan electrodes. Due to the set-down discharge, the amount of wall charges that is sufficient to stably perform the following address discharge may remain uniform in the discharge cells.

In the address period, a negative scan waveform may be sequentially applied to the scan electrodes and a positive address waveform may be simultaneously applied to the address electrodes in synchronization with the scan waveform. A potential difference between the scan waveform and the address waveform may be added with a wall voltage created during the reset period so that an address discharge occurs in discharge cells to which the address waveform is applied. In cells selected by the address discharge, an amount of wall charges is formed that is sufficient to form a sustain discharge when a sustain waveform is applied. In the address period, a positive bias voltage V_{zb} is applied to the sustain electrodes during the address period so as to reduce a potential difference between the sustain electrodes and the scan electrodes and thus prevent a wrong discharge from occurring between the sustain electrodes and the scan electrodes.

In the sustain period, a positive sustain waveform Sus may be alternately applied to the scan electrodes and the sustain electrodes. In the cells selected by the address discharge, the wall voltage in the cells is added with the sustain waveform so that a sustain discharge, (i.e., a display discharge) occurs between the scan electrodes and the sustain electrodes whenever a sustain waveform is applied.

After the sustain discharge is complete, in the erase period, an erase waveform Ramp-ers having a narrow pulse width and a low voltage level may be applied to the sustain electrodes, thus erasing wall charges remaining in all cells on the entire screen.

Wall charge distributions of discharge cells by the driving waveforms are shown in FIG. 3B. More specifically, FIG. 3B shows a view for explaining wall charge distributions of discharge cells by the driving waveforms illustrated in FIG. 3A according to an example arrangement. Other arrangements are also possible.

More specifically, during the set-up period of the reset period, a set-up waveform may be applied to a scan electrode Y and a voltage waveform relatively lower than the set-up waveform may be applied to a sustain electrode Z and an address electrode X so that negative charged particles are accumulated on the scan electrode Y as shown in (a) of FIG. 3B and positive charged particles are accumulated on the sustain electrode Z and the address electrode X.

Thereafter, during the set-down period, a set-down waveform may be supplied to the scan electrode Y and a predetermined bias voltage (e.g., a ground (GND) voltage) is supplied and sustained to the sustain electrode Z and the address electrode X so as to partially erase wall charges excessively accumulated in discharge cells during the set-up period in (b) of FIG. 3B. Due to the erasing process, wall charges may be uniformly distributed in discharge cells.

Then, in the address period, an address discharge may occur based on a scan waveform applied to the scan electrode Y and an address waveform applied to the address electrode X as shown in (c) of FIG. 3B.

Thereafter, in a sustain period, a sustain waveform may be applied alternately to the scan electrode Y and the sustain electrode Z so that a sustain discharge occurs as shown in (d) of FIG. 3B.

Meanwhile, during the set-down period, wall charges accumulated between the scan electrode Y and the address electrode X during the set-up period may be erased and wall charges accumulated between the scan electrode Y and the sustain electrode Z may remain.

Also, if each cell of Red (R), Green (G), or Blue (B) forms a unit pixel and at least one cell of unit pixels is continuously in a turned-off state when a plasma display panel is driven, charged particles in neighboring cells may be diffused to the cell that is continuously in the turned-off state. In this case, the unit pixel may form a single color pattern on a display screen.

The cell that is continuously in the turned-off state should not be turned on when the unit pixel forms the single color pattern. However, during the address period, a wrong discharge may be generated between the scan electrode Y and the sustain electrode Z by the wall charges fixed during the set-down period and the charged particles diffused from the neighboring cells. This is called an “afterimage-generating wrong discharge”. Since an afterimage-generating wrong discharge that occurs during an address period influences the following sustain period, a sustain discharge is maintained and spots may be created.

### First Embodiment

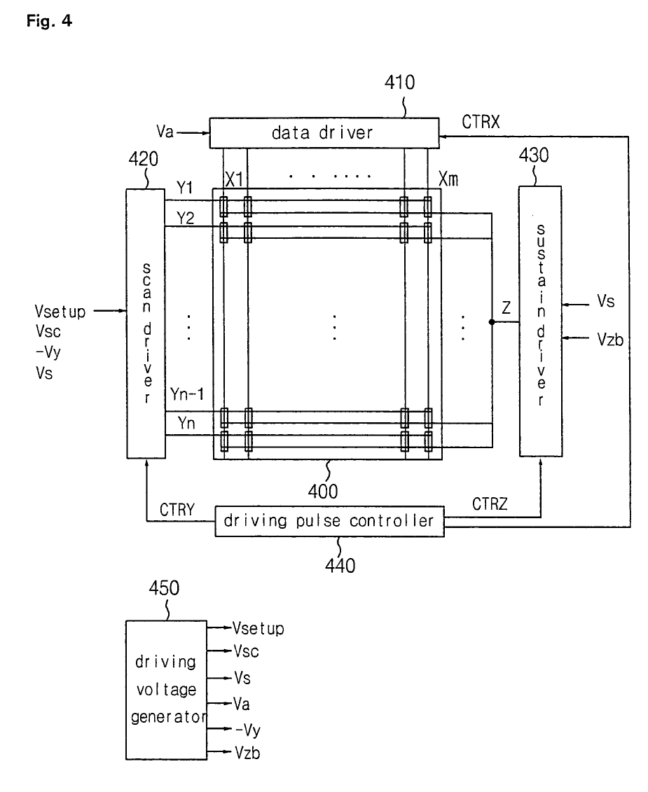

FIG. 4 is a view for explaining structure of a plasma display apparatus according to a first embodiment of the present invention. Other embodiments and configurations are also within the scope of the present invention. As shown in FIG. 4, the plasma display apparatus may include a plasma display panel 400, a data driver 410, a scan driver 420, a sustain driver 430, a driving pulse controller 440 and a driving voltage generator 450.

A plurality of scan electrodes Y₁ through Yₙ, a plurality of sustain electrodes Z, and a plurality of address electrodes X₁ through Xₘ that intersect the scan electrodes Y₁ through Yₙ and the sustain electrodes Z are formed on the plasma display panel 400.

The data driver 410 applies data to the address electrodes X₁ through Xₘ formed on the plasma display panel 400. The data may be image signal data obtained by processing an image signal received from the outside in an image signal processor (not shown). The data driver 410 may sample and latch data in response to a data timing control signal CTRX received from the driving pulse controller 440 and then supply an address pulse (or signal or waveform) with an address voltage Va to the respective address electrodes X₁ through Xₘ.

The scan driver 420 may drive the scan electrodes Y₁ through Yₙ formed on the plasma display panel 400. In a reset period, the scan driver 420 may supply a set-up pulse (or signal or waveform) of a rising ramp waveform obtained from a combination of a sustain voltage Vₛ and a set-up voltage Vₛₑₜᵤₚ to the scan electrodes Y₁ through Yₙ under the control of the driving pulse controller 440.

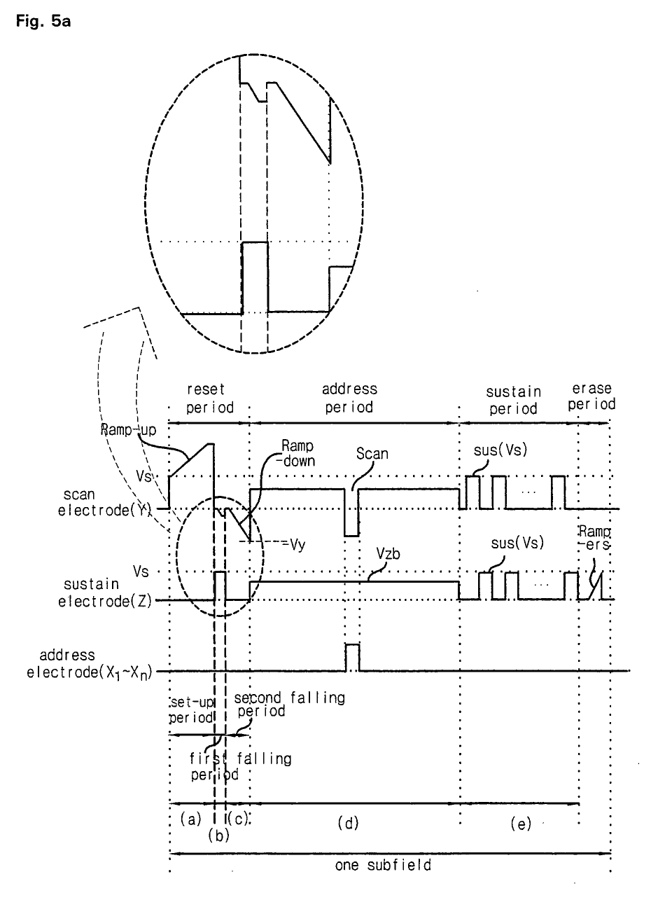

Also, the scan driver 420 may supply a first falling waveform (or signal or pulse) and a second falling waveform (or signal or pulse) that decreases (or falls) to negative voltage levels to the scan electrodes Y₁ through Yₙ. The second falling waveform may be substantially similar to the set-down pulse described above. That is, after the set-up pulse is supplied, wall charges in all discharge cells may be uniformly erased. According to the first embodiment of the present invention, before the second falling waveform is applied, a predetermined falling waveform (i.e., the first falling waveform) may be supplied to the scan electrodes Y₁ through Yₙ. The first falling waveform may be used for erasing wall charges fixed on the scan electrodes Y₁ through Yₙ and sustain electrodes Z of cells that are continuously in a turned-off state. In order to partially erase the wall charges, while the first falling waveform is applied, the sustain driver 430 applies a positive pulse (or signal or waveform) to the sustain electrodes Z. This process will be described later with reference to FIGS. 5A through 8.

Thereafter, in an address period, a scan pulse (or signal or waveform) changing from a scan reference voltage V_{sc} to a scan voltage −V_{y} may be applied sequentially to the respective scan electrodes Y₁ through Yₙ. Then, in a sustain period, the scan driver 420 may supply at least one sustain pulse (or signal or waveform) changing between the ground (GND) voltage and the sustain voltage Vₛ to the scan electrodes Y₁ through Yₙ in order to perform a sustain discharge.

The sustain driver 430 may drive the sustain electrodes Z formed as common electrodes on the plasma display panel 400. The sustain driver 430 of the plasma display apparatus according to the first embodiment of the present invention may apply a positive pulse (or signal or waveform) to the sustain electrodes Z while the first falling pulse is applied to the scan electrodes Y₁ through Yₙ, under the control of the driving pulse controller 440. Also, in the address period, a bias voltage V_{zb} is applied to the sustain electrodes Z, and, in the sustain period, at least one sustain pulse (or signal or waveform) changing between the ground (GND) voltage to the sustain voltage Vₛ may be applied to the sustain electrodes Z in order to perform a sustain discharge.

The driving pulse controller 440 may control the data driver 410, the scan driver 420, and the sustain driver 430 when the plasma display panel 400 is driven. That is, the driving pulse controller 440 may generate timing control signals CTRX, CTRY, and CTRZ for controlling the operation timing and synchronization of the data driver 410, the scan driver 420, and the sustain driver 430 in the reset period, the address period, and the sustain period as described above. The driving pulse controller may transmit the respective timing control signals CTRX, CTRY, and CTRZ to the respective drivers 410, 420, and 430.

The data control signal CTRX may include a sampling clock signal for sampling data, a latch control signal, and a switch control signal for controlling the on/off time of an energy recovery circuit and a driving switch device included in the data driver 410. The scan control signal CTRY may include a switch control signal for controlling the on/off time of an energy recovery circuit and a driving switch device included in the scan driver 420. The sustain control signal CTRZ may include a switch control signal for controlling the on/off time of an energy recovery circuit and a driving switch device included in the sustain driver 430.

The driving voltage generator 450 may generate and supply driving voltages for the driving pulse controller 440 and the respective drivers 410, 420, and 430. That is, the driving voltage generator 450 may generate the set-up voltage Vₛₑₜᵤₚ, the scan reference voltage V_{sc}, the scan voltage −V_{y}, the sustain voltage Vₛ, the address voltage Vₐ, and the bias voltage V_{zb}. These driving voltages may be adjusted according to the composition of discharge gas or the structure of discharge cells. Driving waveforms and wall charge distributions in the plasma display panel, which are implemented by the plasma display apparatus according to the first embodiment of the present invention, will now be described with reference to FIGS. 5A and 5B.

FIG. 5A shows timing diagrams of driving waveforms that are used in the plasma display apparatus according to the first embodiment of the present invention. Other embodiments are timing diagrams are also within the scope of the present invention.

As shown in FIG. 5A, the plasma display apparatus according to the first embodiment of the present invention may be driven to include a reset period for initializing all cells, an address period for selecting cells to be discharged, a sustain period for maintaining the discharge of the selected cells, and an erase period for erasing wall charges in the discharged cells.

In the set-up period of the reset period, a set-up waveform of a rising ramp pulse (or signal or waveform) may be applied simultaneously to all scan electrodes. Thus, a weak dark discharge (set-up discharge) may occur in all discharge cells on the entire screen by the set-up waveform. Due to the set-up discharge, positive wall charges may be accumulated on the address electrodes and the sustain electrodes and negative wall charges may be accumulated on the scan electrodes.

According to the first embodiment of the present invention, in order to prevent an afterimage-generating wrong discharge from occurring, the wall charges formed between the scan electrodes and the sustain electrodes may be selectively erased. In order to perform this process, the set-up waveform may be applied to the scan electrodes during the set-up period and then a first falling waveform with negative polarity gradually deceasing from a ground (GND) voltage may be applied to the scan electrodes. At this time, a positive waveform may be applied to the sustain electrodes in synchronization with the first falling waveform so that a weak erase discharge occurs between the scan electrodes and the sustain electrodes. In at least one embodiment of the present invention, the positive waveform applied to the sustain electrodes may not be in exact synchronization with the first falling waveform. Additionally, the positive waveform may change potential twice during the reset period as shown in FIG. 5A.

Due to the erase discharge, the plasma display apparatus may selectively erase wall charges excessively accumulated on cells that are continuously in a turned-off state. Therefore, the occurrence of a wrong discharge may suppress spots from appearing when a single color pattern is implemented.

The first falling waveform may decrease from approximately a ground (GND) voltage to a minimum voltage level that is higher than −50 volts and lower than −10 volts. If the first falling waveform decreases lower than a threshold value of −50 volts, the erase discharge may be excessively generated between the scan electrodes and the sustain electrodes and a dark afterimage may appear by erase light. If the first falling waveform does not decrease lower than the threshold value of −10 volts, erase discharge may not occur between the scan electrodes and the sustain electrodes.

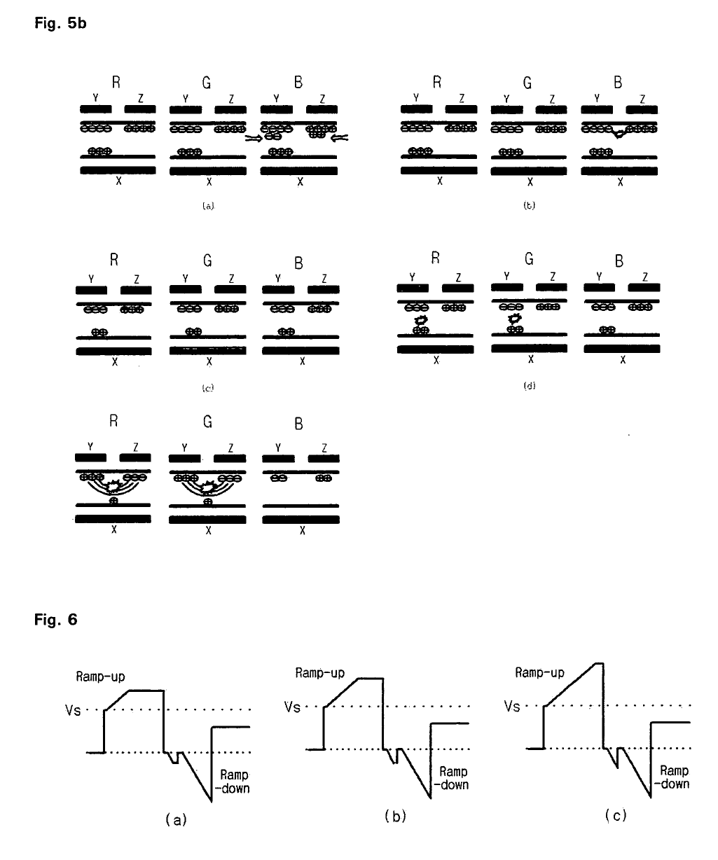

The minimum voltage level of the first falling waveform may be controlled according to the maximum voltage level of the set-up waveform applied during the set-up period. Since the amount of accumulated wall charges may be different according to the maximum voltage level of the set-up waveform, the amount of wall charges to be erased may be controlled based on the minimum voltage level of the first falling waveform. This process will be described below with reference to FIG. 6.

Also, the width of the first falling waveform may be between 10 μs and 30 μs in order to ensure a sufficient erase discharge time.

According to the first embodiment of the present invention, since the first and second falling waveforms are created using a voltage supplied from the same voltage source that has been used for supplying the set-down waveform as discussed above, manufacturing costs required for hardware configuration can be reduced. The first waveform and the second waveform can be created by controlling a switching time of the voltage supplied from the same voltage source.

According to the first embodiment of the present invention, although the first and second falling waveforms are created using a voltage supplied from the same voltage source, the absolute value of the minimum voltage level of the first falling waveform may be equal to or smaller than 30% of the absolute value of the minimum voltage level −V_{y} of the second falling waveform.

If the absolute value of the minimum voltage level of the first falling waveform is greater than 30% of the absolute value of the minimum voltage level −V_{y} of the second falling waveform, erase light generated by the erase discharge between the scan electrodes and the sustain electrodes may increase. Specifically, since a large amount of wall charges may be accumulated in cells that are continuously in the turned-off state, the brightness of erase light emitted from the cells may become higher than the brightness of erase light emitted from different cells. Accordingly, in an image area in which a single color pattern is implemented, a dark afterimage corresponding to a complementary color of the single color may appear. This dark afterimage may be called a “complementary color afterimage”. According to the first embodiment of the present invention, considering the complementary color afterimage that can appear by the first falling waveform, the absolute value of the minimum voltage level of the first falling waveform may be controlled to be equal to or smaller than 30% of the absolute value of the minimum voltage level of the second falling waveform as described above.

Also, according to the first embodiment of the present invention, the positive waveform applied to the sustain electrodes may have a same voltage (Vₛ) level as a sustain waveform applied in the sustain period. Thus, a potential difference may be formed between the positive waveform and the first falling waveform applied to the scan electrodes so that an erase discharge is performed. This may result in reducing manufacturing costs required for hardware configuration.

During the set-down period, a second falling waveform may be applied. The second falling waveform may decrease from an approximate ground (GND) voltage to a predetermined voltage (−V_{y}) level whose minimum voltage level is lower than the first falling waveform. By an erase discharge occurring between the scan electrodes and address electrodes in the cells, wall charges formed between the scan electrodes and the address electrodes may be sufficiently erased. By applying the second falling waveform, the amount of wall charges that is sufficient to create an address discharge may remain uniform in the cells. That is, the second falling waveform may perform a similar function as the set-down waveform as discussed above. As may be seen in FIG. 5A, during the second falling waveform, the sustain electrode may maintain a prescribed level (such as ground). The prescribed level of the sustain electrode is a lower voltage than a bias voltage applied to the sustain electrode in the address period.

In an address period, a negative scan waveform may be applied sequentially to the scan electrodes and a positive address waveform may be applied simultaneously to the address electrodes in synchronization with the scan waveform. A potential difference between the scan waveform and the address waveform may be added with the wall voltage created in the reset period so that an address discharge is generated in cells to which the address waveform is applied. In the cells selected by the address discharge, an amount of wall charges is formed that is sufficient to create a discharge when a sustain waveform of a sustain voltage Vₛ is applied. In the address period, in order to reduce a potential difference between the address electrodes and the scan electrodes and thus prevent a wrong discharge from occurring, a positive bias voltage V_{zb} may be supplied to the sustain electrodes.

In a sustain period, a positive sustain waveform Sus may be applied alternately to the scan electrodes and the sustain electrodes. In the cells selected by the address discharge, the wall voltage in the cells is added with the sustain waveform Sus, so that a sustain discharge (i.e., a display discharge) is generated between the scan electrodes and the sustain electrodes whenever a sustain waveform Sus is applied.

After the sustain discharge is complete, in an erase period, an erase waveform Ramp-ers having a narrow pulse width and a low voltage level is applied to the sustain electrodes to erase wall charges that remain in cells on the entire screen. Wall charge distributions of discharge cells by the driving waveforms illustrated in FIG. 5A will now be described with reference to FIG. 5B.

FIG. 5B is a view for explaining wall charge distributions of discharge cells by the driving waveforms illustrated in FIG. 5A according to an example embodiment of the present invention. Other embodiments are also within the scope of the present invention.

Referring to FIG. 5B, during the set-up period of the reset period, a set-up waveform may be applied to a scan electrode Y and a waveform with a voltage relatively lower than the set-up waveform may be applied to a sustain electrode Z and an address electrodes X. As shown in (a) of FIG. 5B, negative charged particles may be accumulated on the scan electrode Y and positive charged particles may be accumulated on the sustain electrode Z and the address electrode X.

The R and G cells of R, G, and B unit pixels shown in FIG. 5B may be continuously maintained in a turned-on state and the B cell may be continuously maintained in a turned-off state, thereby implementing a single color pattern. Charged particles in the R and G cells that are continuously maintained in the turned-on state are diffused to the B cell that are continuously maintained in the turned-off state.

Thereafter, a first falling waveform may be applied to the scan electrode Y and a positive waveform may be applied to the sustain electrode Z during a predetermined period. Accordingly, as shown in (b) of FIG. 5B, an erase discharge may be generated between the scan electrode Y and the sustain electrode Z of the B cell in which wall charges are excessively formed.

Then, during the set-down period, a second falling waveform whose minimum voltage level is lower than the first falling waveform may be applied to the scan electrode Y, and a predetermined bias voltage (e.g., a waveform of a ground (GND) voltage) is applied to the sustain electrode Z and the address electrode X. Accordingly, as shown in (c) of FIG. 5B, the wall charges created during the set-up period are partially erased. Through this erase process, wall charge distributions of discharge cells may become uniform.

Then, in the address period, an address discharge may be generated by a scan waveform applied to the scan electrode Y and an address waveform applied to the address electrode X as shown in (d) of FIG. 5B.

Thereafter, in the sustain period, a sustain waveform may be at least once applied alternately to the scan electrode Y and the sustain electrode Z so that a sustain discharge is generated as shown in (e) of FIG. 5B.

FIG. 6 shows waveforms for explaining a relationship between the set-up waveform and the first falling waveform that is used in the plasma display apparatus according to the first embodiment of the present invention. Other embodiments and waveforms are also within the scope of the present invention.

As shown in FIG. 6, according to the first embodiment of the present invention, the maximum voltage level of the set-up waveform applied to the scan electrode may be adjusted as desired. The maximum voltage level of the set-up waveform may also be temporarily adjusted in a unit of a frame, or, more finely, in a unit of a subfield. The maximum voltage level of the set-up waveform may also be spatially adjusted in a unit of a scan electrode line. As the maximum voltage level of the set-up waveform is higher, the amount of wall charges formed in each discharge cell increases and the wall charges are saturated when the amount of wall charge reaches a predetermined amount.

As such, according to the first embodiment of the present invention, the minimum voltage level of the first falling waveform may be controlled according to the maximum voltage level of the set-up waveform since the amount of wall charges increases according to increases in the maximum voltage level of the set-up pulse. As shown in FIG. 5B (a) through (c), by reducing the minimum voltage level of the first falling waveform according to increases in the maximum voltage level of the set-up waveform, wall charges between the scan electrode and the sustain electrode may be sufficiently erased.

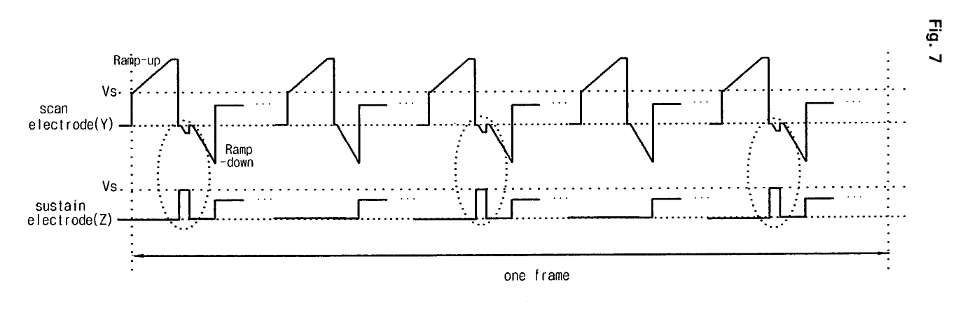

FIG. 7 shows modified waveforms that are used in the plasma display apparatus according to the first embodiment of the present invention. Other embodiments and waveforms are also within the scope of the present invention.

As shown in FIG. 7, according to the first embodiment of the present invention, a first falling waveform is applied to at least one subfield in a frame. If the first falling waveform is included in all subfields of a frame, the occurrence of an afterimage-generating wrong discharge may be suppressed. However, the application durations of different waveforms may be relatively reduced due to the temporal limitation of the frame. For example, if a sustain period for emitting sustain discharge light to be actually displayed is reduced, the brightness of a display screen may decrease and contrast may be lowered. Accordingly, in the first embodiment of the present invention, the number of the first falling waveforms that are applied in a unit of a frame is decided considering two aspects of temporal limitation and afterimage-generating wrong discharge prevention.

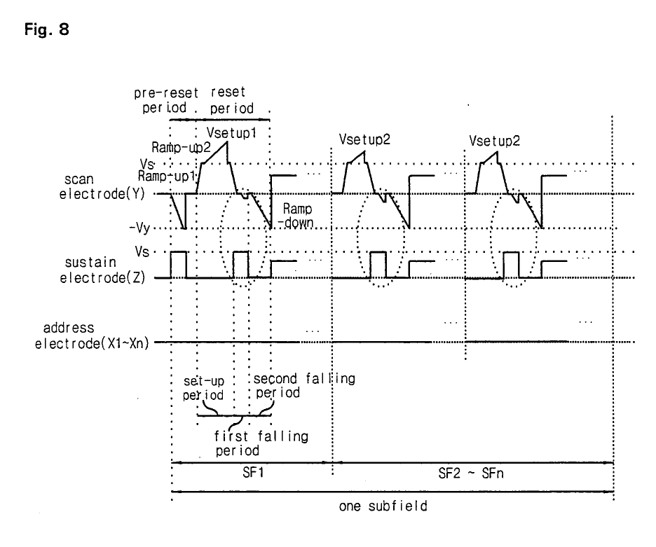

FIG. 8 shows timing diagrams for explaining a waveform including a pre-reset waveform that is used in the plasma display apparatus according to the first embodiment of the present invention. Other embodiments and timing diagrams are also within the scope of the present invention.

FIG. 8 shows the modified waveforms that are used in the plasma display apparatus according to the first embodiment of the present invention. FIG. 8 shows a pre-reset period before the reset period in which a positive waveform is applied to one of a sustain electrode pair and a negative waveform is applied to the other one of the sustain electrode pair. For example, during the pre-reset period, a gradually falling negative waveform may be applied to scan electrodes and a positive waveform of a sustain voltage Vₛ may be applied to sustain electrodes. Also, a ground (GND) voltage (i.e., 0 volts) may be applied to the address electrodes. At this time, in all discharge cells, a dark discharge may occur between the scan electrodes and sustain electrodes, and between the sustain electrodes and address electrodes so that wall charges are formed.

Since the pre-reset waveform is applied before a reset period of an initial subfield for each frame, all discharge cells may have the same wall charge distribution and are initialized. By ensuring stable wall charge distribution through the pre-set period, the maximum voltage level of a set-up waveform of each of the subfields in a frame may be reduced. Also, the reduction in the maximum voltage level of the set-up waveform may lead to reduction of the set-up period, thereby ensuring a sufficient driving margin.

During the set-up period of the reset-period, a first positive ramp waveform Ramp-up 1 and a second positive ramp waveform Ramp-up 2 are successively applied to the scan electrodes and 0 volts is applied to the sustain electrodes and the address electrodes. The voltage of the first positive ramp waveform Ramp-up 1 increases from 0 volts to a positive sustain voltage Vₛ and the voltage of the second positive ramp waveform Ramp-up 2 increases from the positive sustain voltage Vₛ to a maximum voltage Vₛₑₜᵤₚ 1 or Vₛₑₜᵤₚ 2 higher than the positive sustain voltage Vₛ. By the set-up period, wall charges are accumulated in all discharge cells.

Here, according to the first embodiment of the present invention, the maximum voltage level Vₛₑₜᵤₚ 1 of a set-up waveform of a first subfield SF1 applied to the scan electrodes is different from the maximum voltage level Vₛₑₜᵤₚ 2 of set-up waveforms of the remaining subfields SF2 through SFn. The maximum voltage level Vₛₑₜᵤₚ 1 of the first subfield SF1 is set higher than the maximum voltage level Vₛₑₜᵤₚ 1 of the remaining subfields SF2 through SFn. This is because wall charge distributions of all discharge cells are initialized during the pre-reset period. Accordingly, in a first subfield SF1 following a pre-reset period, the maximum voltage level of a set-up waveform is higher than the maximum voltage levels of set-up waveforms of the remaining subfields SF2 through SFn. This may be done in order to obtain the same wall charge distribution as the remaining subfields SF2 through SFn.

After the set-up period, a first negative falling waveform is applied to the scan electrodes to decrease to the ground (GND) voltage lower than the maximum voltage level of the set-up waveform and then gradually rise. A positive waveform may be applied to the sustain electrodes Z in synchronization with the first falling waveform so that a weak erase discharge occurs between the scan electrodes and the sustain electrodes. The positive waveform may not be in exact synchronization with the first falling waveform.

According to the first embodiment of the present invention, in the driving waveform including the pre-reset period, the minimum voltage level of the first falling waveform of the first subfield SF1 is different from the minimum voltage levels of the first falling waveforms of the remaining subfields SF2 through SFn. Due to the pre-reset waveform, wall charges formed after the set-up period in the first subfield SF1 may be less than all charges formed after the set-up periods of the remaining subfields SF2 through SFn. This is because a certain amount of wall charges have been formed in advance in the remaining subfields SF2 through SFn. That is, the first subfield SF1 may control the first falling waveform to generate a weak erase discharge and the remaining subfields SF2 through SFn may control the first falling waveform to generate an erase discharge stronger than in the first subfield SF1.

The minimum voltage level of the first falling waveform of the first subfield SF1 may be between −20 volts and −10 volts and the minimum voltage levels of the first falling waveforms of the remaining subfields SF2 through SFn may be between −50 volts and −10 volts.

If the first falling waveform decreases lower than the threshold value of −20 volts in the first subfield SF1 or lower than the threshold value of −50 volts in the remaining subfields SF2 through SFn, an erase discharge may be excessively generated between the scan electrodes and the sustain electrodes and a dark afterimage may appear. Also, if the first falling waveform does not decrease lower than −10 volts, no erase discharge may occur between the scan electrodes and the sustain electrodes.

Also, in order to ensure an appropriate erase discharge period, the width of the first falling waveform of the first subfield SF1 may be between 10 μs and 30 μs and the width of each of the first falling waveforms of the remaining subfields SF2 through SFn may be between 20 μs and 30 μs.

A set-down period, an address period, and a sustain period have been described above with reference to FIG. 5A, and therefore further detailed descriptions are not provided.

By selectively erasing wall charges excessively accumulated on cells that are continuously in a turned-off state in an area displaying a single color pattern when the plasma display panel is driven, using the first falling waveform, a spot problem may be more efficiently improved. Further, by limiting the minimum voltage level of the first falling waveform, a complementary color afterimage may be prevented from being generated.

### Second Embodiment

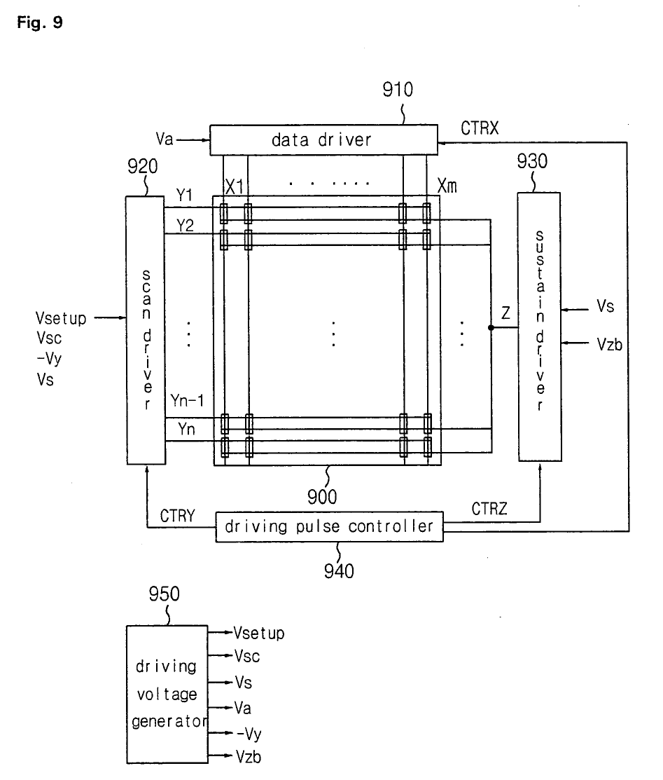

FIG. 9 is a view for explaining structure of a plasma display apparatus according to a second embodiment of the present invention. Other embodiments and configurations are also within the scope of the present invention.

More specifically, FIG. 9 shows that the plasma display apparatus according to the second embodiment of the present invention may include a plasma display panel 900, a data driver 910, a scan driver 920, a sustain driver 930, a driving pulse controller 940 and a driving voltage generator 950.

A plurality of scan electrodes Y₁ through Yₙ, a plurality of sustain electrodes Z, and a plurality of address electrodes X₁ through Xₘ that intersect the scan electrodes Y₁ through Yₙ and the sustain electrodes Z are formed on the plasma display panel 900.

The data driver 910 applies data to the address electrodes X₁ through Xₘ formed on the plasma display panel 900. The data may be image signal data obtained by processing an image signal received from the outside in an image signal processor (not shown). The data driver 910 may sample and latch data in response to a data timing control signal CTRX received from the driving pulse controller 940. The data driver 910 may then supply an address pulse with an address voltage Va to the respective address electrodes X₁ through Xₘ.

The scan driver 920 may drive the scan electrodes Y₁ through Yₙ formed on the plasma display panel 900. In a reset period, the scan driver 920 may supply a set-up pulse (or signal or waveform) of a ramp waveform obtained from a combination of a sustain voltage Vₛ and a set-up voltage Vₛₑₜᵤₚ applied from the driving voltage generator 950 to the scan electrodes Y₁ through Yₙ under the control of the driving pulse controller 940.

Also, the scan driver 920 may apply a first falling waveform (or signal or pulse) and a second falling waveform (or signal or pulse) that decreases to negative voltage levels to the scan electrodes Y₁ through Yₙ. The second falling waveform may be substantially equal to the set-down waveform described above. That is, after a set-up waveform is applied, wall charges in all discharge cells may be uniformly erased. According to the second embodiment of the present invention, before the second falling waveform is applied, a predetermined falling waveform (or signal or pulse) (i.e., the first falling waveform) may be applied to the scan electrodes Y₁ through Yₙ. The first falling waveform may be used for erasing wall charges fixed on the scan electrodes Y₁ through Yₙ and sustain electrodes Z of cells that are continuously in a turned-off state. In order to partially erase the wall charges, while the first falling waveform is applied, the sustain driver 930 applies a positive pulse (or signal or waveform) to the sustain electrodes Z.

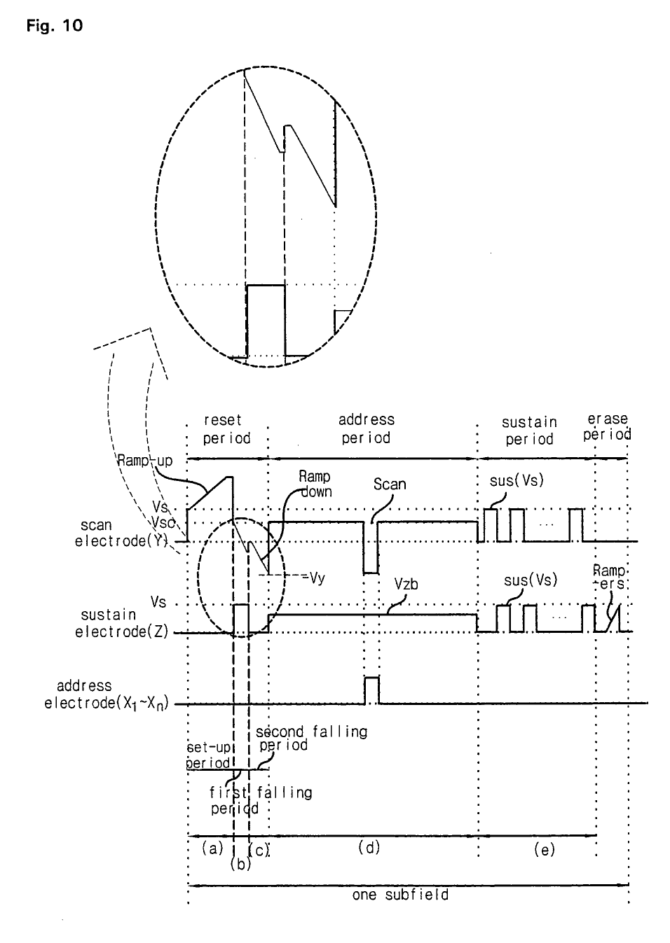

According to the second embodiment of the present invention, the first falling waveform decreases from a first voltage level lower than the maximum voltage level of the set-up waveform, and the second falling waveform decreases from a second voltage level lower than the first voltage level. The first voltage level may be equal to a voltage level V_{sc} of a scan reference waveform that is applied to the scan electrodes Y₁ through Yₙ in a scan period and the second voltage level may be a ground (GND) voltage. A further description of this will be described below with reference to FIG. 10.

In an address period, a scan pulse (or signal or waveform) changing from the scan reference voltage V_{sc} to a scan voltage −V_{y} may be applied sequentially to the respective scan electrodes Y₁ through Yₙ. Then, in a sustain period, the scan driver 920 may apply at least one sustain pulse (or signal or waveform) changing between the ground (GND) voltage and the sustain voltage Vₛ to the scan electrodes Y₁ through Yₙ in order to perform a sustain discharge.

The sustain driver 930 may drive the sustain electrodes Z formed as common electrodes on the plasma display panel 900. The sustain driver 930 of the plasma display apparatus according to the second embodiment of the present invention may apply a positive pulse (or signal or waveform) with the same voltage Vₛ as the sustain pulse to the sustain electrodes Z while the first falling waveform is applied to the scan electrodes Y₁ through Yₙ under the control of the driving pulse controller 940. Also, in the address period, a bias voltage V_{zb} may be applied to the sustain electrodes Z and in the sustain period, at least one sustain waveform (or signal or pulse) changing between the ground (GND) voltage to the sustain voltage Vₛ may be applied to the sustain electrodes Z in order to perform a sustain discharge.

The driving pulse controller 940 may control the data driver 910, the scan driver 920, and the sustain driver 930 when the plasma display panel 900 is driven. That is, the driving pulse controller 940 may generate timing control signals CTRX, CTRY, and CTRZ for controlling the operation timing and synchronization of the data driver 910, the scan driver 920, and the sustain driver 930 in the reset period, the address period, and the sustain period as described above. The driving pulse controller 940 may also transmit the respective timing control signals CTRX, CTRY, and CTRZ to the respective drivers 910, 920, and 930.

The data control signal CTRX may include a sampling clock signal for sampling data, a latch control signal, and a switch control signal for controlling the on/off time of an energy recovery circuit and a driving switch device included in the data driver 910. The scan control signal CTRY may include a switch control signal for controlling the on/off time of an energy recovery circuit and a driving switch device included in the scan driver 920. The sustain control signal CTRZ may include a switch control signal for controlling the on/off time of an energy recovery circuit and a driving switch device included in the sustain driver 930.

The driving voltage generator 950 may generate and supply driving voltages required for the driving pulse controller 940 and the respective drivers 910, 920, and 930. That is, the driving voltage generator 950 may generate the set-up voltage Vₛₑₜᵤₚ, the scan reference voltage V_{sc}, the scan voltage −V_{y}, the sustain voltage Vₛ, the address voltage Vₐ, and the bias voltage V_{zb}. These driving voltages may be adjusted according to the composition of discharge gas or the structure of discharge cells. Driving waveforms that are implemented by the plasma display apparatus according to the second embodiment of the present invention will now be described with reference to FIG. 10.

FIG. 10 shows timing diagrams of driving waveforms that are used in the plasma display apparatus according to the second embodiment of the present invention. Other embodiments and timing diagrams are also within the scope of the present invention.

More specifically, FIG. 10 shows that the plasma display apparatus according to the second embodiment of the present invention is driven according to a reset period for initializing all cells, an address period for selecting cells to be discharged, a sustain period for maintaining the discharge of the selected cells, and an erase period for erasing wall charges in the discharged cells.

In the set-up period of the reset period, a set-up waveform of a rising ramp pulse (or signal or waveform) may be applied simultaneously to all scan electrodes. Thus, a weak dark discharge (set-up discharge) may occur in discharge cells on the entire screen by the set-up waveform. Due to the set-up discharge, positive wall charges may be accumulated on address electrodes and sustain electrodes and negative wall charges may be accumulated on scan electrodes.

According to the second embodiment of the present invention, in order to prevent an afterimage-generating wrong discharge from occurring, wall charges formed between the scan electrodes and the sustain electrodes may be selectively erased. In order to perform this process, during the set-up period, a rising ramp waveform may be applied and a first falling waveform decreasing from a first voltage level lower than the maximum voltage level of the set-up waveform to a predetermined negative voltage level may be applied to the scan electrodes. A positive waveform may also be applied to the sustain electrodes in synchronization with the first falling waveform so that a weak erase discharge occurs between the scan electrodes and the sustain electrodes. The positive waveform may not be in exact synchronization with the first falling waveform.

Due to the erase discharge, the plasma display apparatus may selectively erase wall charges excessively accumulated in cells that are continuously in a turned-off state. Accordingly, the occurrence of a wrong discharge may be suppressed and spots may be prevented from appearing when a single color pattern is implemented.

If a positive waveform with a high voltage level (e.g., a positive waveform with a sustain voltage Vₛ) is applied to the sustain electrodes in order to erase fixed wall charge, a strong discharge may be generated due to the excessive wall charges formed during the set-up period. The strong discharge may influence the following sustain discharge and may cause screen distortion. According to the second embodiment of the present invention, the first falling waveform may have a waveform gradually decreasing from a first positive voltage level. That is, when the first falling waveform is applied, since the scan electrodes have the potential of the first positive voltage level and the sustain electrodes have the potential of the sustain voltage level, a potential difference between the scan electrodes and the sustain electrodes is not large and accordingly the occurrence of strong discharge can be suppressed.

According to the second embodiment of the present invention, the first voltage level may be lower than the maximum voltage level of the set-up waveform. The first voltage level may be equal to the scan reference voltage V_{sc} that is applied in the scan period. Accordingly, the occurrence of strong discharge may be suppressed and manufacturing costs may be reduced for hardware configuration. Also, since an appropriate potential difference is formed between the first falling waveform and the positive waveform applied to the sustain electrodes, wall charges may be erased while the first falling waveform is applied. The first voltage level (i.e., the scan reference voltage V_{sc}) may be between 110 volts and 130 volts.

According to the second embodiment of the present invention, due to the first falling waveform decreasing from the first positive voltage level as described above, a sustain voltage Vₛ with a high voltage level can be used as a positive waveform to be applied to the sustain electrodes in order to stably erase wall charges. By using the same voltage Vₛ as the sustain waveform to form an appropriate potential difference between the first falling waveform and the voltage Vₛ that allows an erase discharge, manufacturing costs for hardware configuration may be reduced. Also, since an energy recovery circuit is provided in a sustain voltage applying terminal, Electromagnetic Interference (EMI) that is generated when the plasma display panel is driven may be reduced and the peaking components of positive waveforms may be minimized.

The negative minimum voltage level of the first falling waveform may be between −50 volts and −10 volts. If the first falling waveform decreases lower than the threshold value −50 volts, an erase discharge may be excessively generated between the scan electrodes and the sustain electrodes, which generates a dark afterimage. If the first falling waveform does not decrease lower than −10 volts, the amount of erased wall charges may not be sufficient to suppress a wrong discharge between the scan electrodes and the sustain electrode. This is because wall charges are erased at a negative voltage level while the erase discharge begins when the first falling waveform is applied.

In the second embodiment of the present invention, the negative minimum voltage level of the first falling waveform is controlled according to the maximum voltage level of the set-up waveform applied during the set-up period. The width of the first falling waveform may be between 10 μs and 30 μs in order to ensure a sufficient erase discharge time. Also, the first and second falling waveforms may be created using a voltage supplied from the same voltage source. Also, in the second embodiment of the present invention, although the first and second falling waveforms are created using the voltage supplied from the same voltage source, the absolute value of the minimum voltage level of the first falling waveform may be equal to or smaller than 30% of the absolute value of the minimum voltage level −V_{y} of the second falling waveform.

Details regarding the set-down period, the address period, the sustain period, and the erase period according to the second embodiment of the present invention have been described above, and therefore further detailed descriptions are omitted.

By using a first falling waveform to selectively erase wall charges excessively accumulated in cells that are continuously in a turned-off state in an area representing a single color pattern when a plasma display panel is driven, spots may be prevented from appearing.

Since the first falling waveform has a waveform decreasing from a positive voltage level, the occurrence of strong discharge may be suppressed even when a high voltage is applied to sustain electrodes and screen distortion of the plasma display panel may also be suppressed. Also, by limiting the minimum voltage level of the first falling waveform, a complementary color afterimage may be prevented from being generated.

Embodiments with the present invention may provide a plasma display apparatus that includes a plasma display panel on which a plurality of sustain electrode pairs are formed, each including a scan electrode and a sustain electrode. The plasma display apparatus may also include a driver to drive each sustain electrode pair and a driving pulse controller that controls the driver to sequentially apply a first falling waveform and a second falling waveform to the scan electrode and to apply a positive waveform to the sustain electrode while applying the first falling waveform in the reset period.

The positive waveform may have the same voltage level as a sustain waveform that is applied to the sustain electrode. The minimum voltage levels of the first and second falling waveforms may be negative. The minimum voltage level of the first falling waveform may be different from the minimum voltage of the second falling waveform. Additionally, the minimum voltage level of the first falling waveform may be higher than the minimum voltage of the second falling waveform. Still further, the absolute value of the minimum voltage level of the first falling waveform may be equal to or smaller than 30% of the absolute value of the minimum voltage level of the second falling waveform.

In the reset period, the minimum voltage level of the first falling waveform may be controlled according to the maximum voltage level of a set-up waveform that is applied to the scan electrode.

The minimum voltage level of the first falling waveform may be between −50 Volts and −10 Volts. The width of the first falling waveform may be between 10 μs and 30 μs. The first and second falling waveforms may be supplied from the same voltage source. Still further, the first falling waveform may be applied in at least one subfield period. Additionally, while the second falling waveform is applied, the sustain electrode may maintain the ground (GND) level.

Before the reset period, a pre-reset period may be provided during which a positive waveform may be applied to one of the sustain electrode pair and during which a negative waveform may be applied to the other one of the sustain electrode pair.

The minimum voltage level of a first falling waveform in a subfield including the pre-reset period may be different from the minimum voltage level of a first falling waveform in at least one of the remaining subfields. The maximum voltage level of a set-up waveform in a subfield including the pre-reset period may be different from the maximum voltage level of a set-up waveform in at least one of the remaining subfields.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to sequentially apply a first falling waveform and a second falling waveform falling or decreasing from a same voltage level as the first falling waveform to the scan electrode and to apply a positive waveform to the sustain electrode while applying the first falling waveform in the reset period. The same voltage level may be a ground (GND) voltage. Further, while the second falling waveform is applied, the sustain electrode may maintain the ground (GND) level.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to sequentially apply a first falling waveform decreasing from a first voltage level lower than the maximum voltage level of a set-up waveform and then to apply a second falling waveform decreasing from a second voltage level lower than the first voltage level to the scan electrode, and to apply a positive waveform to the sustain electrode while applying the first falling waveform in the reset period.

The first voltage level may have a same voltage level as a scan reference waveform that is applied to the scan electrode. Further, while the second falling waveform is applied, the sustain electrode may maintain the ground (GND) level.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to apply a first falling waveform and a second falling waveform whose minimum voltage levels are negative to the scan electrode, and to apply a positive waveform to the sustain electrode while applying the first falling waveform in the reset period.

In at least one embodiment, a plasma display apparatus may include a plasma display panel on which a plurality of sustain electrode pairs are formed, each including a scan electrode and a sustain electrode. A driver may drive each sustain electrode pair. A driving pulse controller may control the driver to apply a first falling waveform and a second falling waveform whose minimum voltage levels are negative to the scan electrode, to apply a positive waveform to the sustain electrode while applying the first falling waveform and to maintain the sustain electrode at a ground (GND) level while applying the second falling waveform in the reset period.

A driving method of a plasma display apparatus may also be provided that includes (a) applying a set-up waveform to the scan electrode; (b) applying a first falling waveform whose minimum voltage level is negative to the scan electrode and applying a positive waveform to the sustain electrode while the first falling waveform is applied; and (c) applying a second falling waveform whose minimum voltage level is negative to the scan electrode.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A plasma display apparatus, comprising:
a plasma display panel having a plurality of sustain electrode pairs, each including a scan electrode and a sustain electrode; and
a driving device to apply reset signals during a reset period, the reset signals including a first falling waveform and a second falling waveform applied to at least one of the scan electrodes and a positive waveform applied to at least one of the sustain electrodes while applying the first falling waveform.

2. The plasma display apparatus according to claim 1, wherein the positive waveform changes potential at least once during the reset period.

3. The plasma display apparatus according to claim 1, wherein the positive waveform has approximately a same voltage level as a sustain waveform applied to at least one sustain electrode during a sustain period.

4. The plasma display apparatus according to claim 1, wherein the first falling waveform decreases to a first voltage level and the second falling waveform decreases to a second voltage level.

5. The plasma display apparatus according to claim 4, wherein the first voltage level and the second voltage level are negative voltage levels.

6. The plasma display apparatus according to claim 4, wherein the first voltage level is different than the second voltage level.

7. The plasma display apparatus according to claim 4, wherein the first voltage level is greater than the second voltage level.

8. The plasma display apparatus according to claim 7, wherein an absolute value of the first voltage level is equal to or smaller than 30% of an absolute value of the second voltage level.

9. The plasma display apparatus according to claim 4, wherein the driving device controls the first voltage level of the first falling waveform based on a maximum voltage level of a set-up waveform applied to the scan electrode during the reset period.

10. The plasma display apparatus according to claim 4, wherein the first voltage level is between −50 volts and −10 volts.

11. The plasma display apparatus according to claim 1, wherein a width of the first falling waveform is between 10 μs and 30 μs.

12. The plasma display apparatus according to claim 1, further comprising a voltage source to supply the first and second falling waveforms.

13. The plasma display apparatus according to claim 1, wherein the first falling waveform is applied in at least one subfield.

14. The plasma display apparatus according to claim 1, wherein the driving device maintains the sustain electrode at a prescribed level while the second falling waveform is applied.

15. The plasma display apparatus according to claim 14, wherein the prescribed level comprises a substantially ground level.

16. The plasma display apparatus according to claim 14, wherein the prescribed level is a lower voltage than a bias voltage applied to the sustain electrode in an address period.

17. The plasma display apparatus according to claim 1, wherein the driving device applies a positive waveform to one of the sustain electrode pair and applies a negative waveform to the other one of the sustain electrode pair during a pre-reset period, the pre-set period being prior to the reset period for that particular subfield.

18. The plasma display apparatus according to claim 17, wherein the first falling waveform decreases to a first voltage level and the first voltage level in a first subfield is different than the first voltage level of a subsequent subfield.

19. The plasma display apparatus according to claim 1, wherein a maximum voltage level of a set-up waveform in a first subfield is different than a maximum voltage level of a subsequent set-up waveform in at least one subfield following the first subfield.

20. A plasma display apparatus comprising:
a plasma display panel having a scan electrode and a sustain electrode; and
a driving device to apply a first falling waveform signal and a second falling waveform signal to the scan electrode in a reset period and to apply a positive waveform to the sustain electrode at substantially a same time as the first failing waveform.

21. The plasma display apparatus according to claim 20, wherein the driving device decreases the first falling waveform and the second falling waveform from a same starting voltage.

22. The plasma display apparatus according to claim 21, wherein the same starting voltage comprises a substantially ground voltage.

23. The plasma display apparatus according to claim 20, wherein the driving device maintains the sustain electrode at a prescribed level while the driving device applies the second falling waveform to the scan electrode.

24. The plasma display apparatus according to claim 23, wherein the prescribed level comprises a substantially ground level.

25. The plasma display apparatus according to claim 23, wherein the prescribed level is a lower voltage than a bias voltage applied to the sustain electrode in an address period.

26. A plasma display apparatus comprising:
a plasma display panel having a scan electrode and a sustain electrode; and
a driving device to apply a first falling waveform and a second falling waveform to the scan electrode in a reset period, the first falling waveform decreasing from the first voltage level lower than a maximum voltage level of a set-up waveform, the driving device to apply the second falling waveform decreasing from a second voltage level lower than the first voltage level.

27. The plasma display apparatus according to claim 26, wherein the driving device further to apply a positive waveform to the sustain electrode in the reset period.

28. The plasma display apparatus according to claim 26, wherein the first voltage level has substantially a same voltage level as a scan reference waveform applied to the scan electrode in an address period.

29. The plasma display apparatus according to claim 26, wherein the driving device maintains a prescribed voltage level on the sustain electrode while the driving device applies the second falling waveform.

30. The plasma display apparatus according to claim 29, wherein the prescribed voltage comprises a substantially ground voltage.

31. The plasma display apparatus according to claim 29, wherein the prescribed level is a lower voltage than a bias voltage applied to the sustain electrode in an address period.

32. A plasma display apparatus comprising:
a plasma display panel having a scan electrode and a sustain electrode; and
a driving device to apply a first falling waveform and a second falling waveform to the scan electrode in a reset period and to apply a positive waveform to the sustain electrode in the reset period, the driving device to apply the first positive waveform to the sustain electrode at a substantially same time as the driving device to apply the first falling waveform, the first and second falling waveforms each having negative voltage values.

33. A driving method of a plasma display apparatus having discharge cells formed by a plurality of sustain electrode pairs, each including a scan electrode and a sustain electrode, and a plurality of address electrodes intersecting the plurality of sustain electrode pairs, the driving method comprising:
applying a set-up waveform to the scan electrode;
applying a first falling waveform to the scan electrode in a reset period;
applying a positive waveform to the sustain electrode while applying the first falling waveform to the scan electrode; and
applying a second falling waveform to the scan electrode after the first falling waveform.
